(19) United States
(12) Patent Application Publication
(10) Pub. No.: US 2015/0049085 A1
(43) Pub. Date: Feb. 19, 2015

(54) PIXEL-BASED OR VOXEL-BASED MESH EDITING

(71) Applicant: Schlumberger Technology Corporation, Sugar Land, TX (US)

(72) Inventors: Bjarte Dysvik, Royneberg (NO); Luke Cartwright, Heswall (GB)

(21) Appl. No.: 14/459,849

(22) Filed: Aug. 14, 2014

Related U.S. Application Data
(60) Provisional application No. 61/866,868, filed on Aug. 16, 2013.
(60) Provisional application No. 61/890,646, filed on Oct. 14, 2013.
(60) Provisional application No. 61/902,835, filed on Nov. 12, 2013.

(51) Int. Cl. G06T 7/40; G06T 15/08

(52) U.S. Cl. CPC G06T 7/40; G06T 15/08
USPC 345/424; 345/582

(57) ABSTRACT

Methods, systems, and computer-readable media for editing a mesh representing a surface are provided. The method includes receiving a representation of an object. The representation includes the mesh and a plurality of discrete elements comprising one or more boundary elements. The mesh is associated with the one or more boundary elements. The method also includes changing an edited element of the plurality of discrete elements from a boundary element to a non-boundary element or from a non-boundary element to a boundary element. The method also includes locally recalculating a portion the mesh based on the changing.

### CROSS-REFERENCE TO RELATED APPLICATIONS

This application claims priority to U.S. Provisional Patent Application No. 61/866,868, which was filed on Aug. 16, 2013; U.S. Provisional Patent Application No. 61/890,646 which was filed on Oct. 14, 2013; and U.S. Provisional Patent Application No. 61/902,835 which was filed Nov. 12, 2013. The foregoing provisional applications are incorporated herein by reference in their entirety.

### BACKGROUND

In computer models, objects may be discretized into two-dimensional pixels or three-dimensional voxels, which may be discrete squares or cubes that contain information, for example, color, porosity, etc., about a relatively small area or volume of the object. A single object may be represented by millions, or more, such pixels and/or voxels. Further, surfaces of the object may be represented by meshes. Meshes are formed by a series of vertices that are connected by edges to form elements, e.g., triangles, in a process known as “tessellation.”

In some contexts, a user may edit the representation of the object, e.g., the mesh of the surface. For example, two portions of an object may be connected, despite initially being represented as disconnected in the model. In other cases, the two portions may be disconnected, despite being represented as connected in the model. In such cases, the meshes may be changed to account for the changed representation.

Such changes in the surface features of the object may result in mesh intersections. Mesh intersections may be problematic, however, because they may lead to inaccuracies in calculations based on the model. For example, such calculations ma consider the volume of the object, or a certain part of the object. However, where the mesh intersects, the volume of the intersection may be counted twice, or not at all.

Various techniques have been implemented to avoid or remove such intersections. For example, rules are sometimes applied to ensure that the edited meshes do not intersect, thereby constraining the editing that can occur. In other cases, after the editing occurs, the boundaries of the meshes may be checked to find areas of overlap. If overlap is found, the mesh may revert to the previous state, and the system may re-attempt the editing process. However, especially in the case of large meshes with millions of elements (or more), such techniques may be computationally-intensive, and may result in lengthy runtimes in situations where real-time or near-real-time operation may be desired.

### SUMMARY

Embodiments of the present disclosure provide systems, methods, and computer-readable media that provide mesh editing processes. The mesh editing processes may include employing a voxel-based volume definition wrapped by a mesh. The voxels are defined in a volume grid, and the mesh may be generated from the voxels that define the edges of the object. To edit the mesh, one or more voxels are added to or subtracted from the volume, and the mesh is locally recalculated using the updated voxel definitions. Further, a data structure, such as an octree, mapping the edge voxels in the volume grid may be constructed, so as to speed the editing process. Once the edit operation occurs, the data structure may be updated, and the portion of the mesh affected b the voxel editing may be recalculated.

It will be appreciated that the foregoing summary is intended merely to introduce certain aspects of the disclosure. These other aspects are more fully described below. As such, this summary is not intended to be limiting on the claims.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a flowchart of a method for mesh editing, according to an embodiment.

FIG. 2 illustrates a two-dimensional conceptual view of a discretized area or volume, according to an embodiment.

FIG. 3 illustrates a two-dimensional conceptual view of a mesh associated with the discrete elements, according to an embodiment.

FIG. 4 illustrates a conceptual schematic view of a data structure for the discrete elements, according to an embodiment.

FIG. 5 illustrates a two-dimensional conceptual view of the elements of FIG. 2 after an editing operation, according to an embodiment.

FIG. 6 illustrates a two-dimensional conceptual view of the mesh associated with the edited elements of FIG. 5, according to an embodiment.

FIG. 7 illustrates a schematic view of a computing system, according to an embodiment.

### DETAILED DESCRIPTION

The following detailed description refers to the accompanying drawings. Wherever convenient, the same reference numbers are used in the drawings and the following description to refer to the same or similar parts. While several embodiments and features of the present disclosure are described herein, modifications, adaptations, and other implementations are possible, without departing from the spirit and scope of the present disclosure.

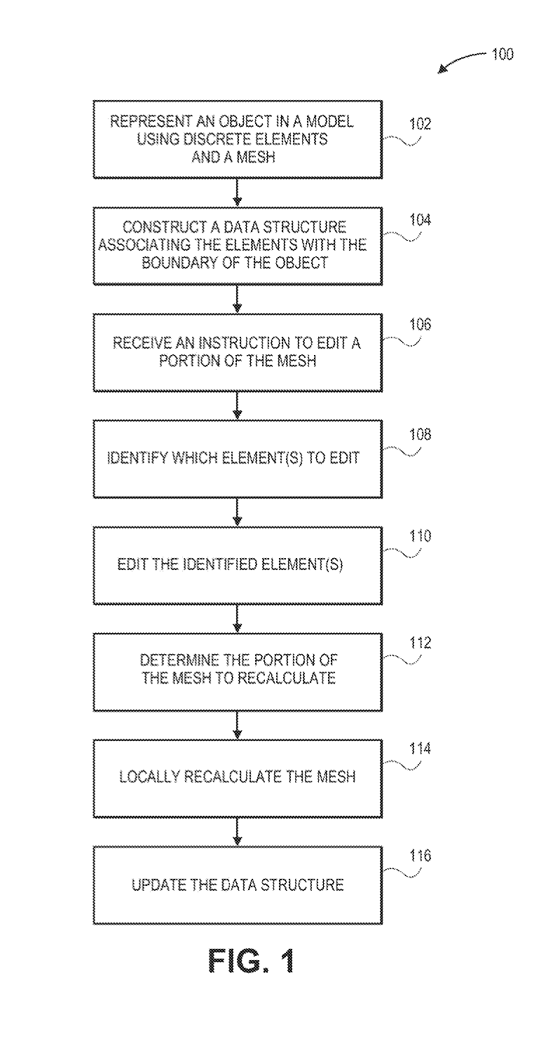

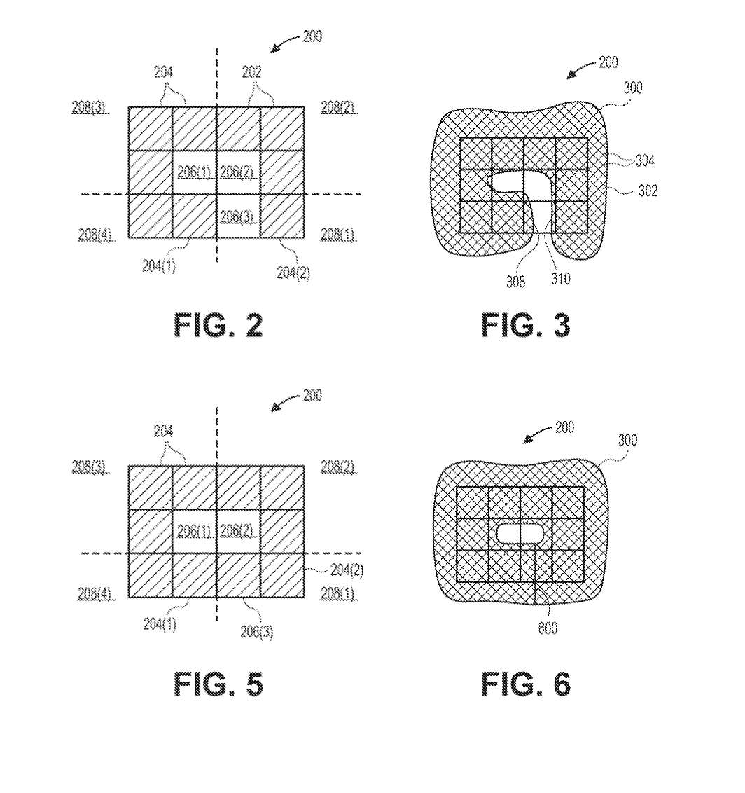

FIG. 1 illustrates a flowchart of a method 100 for editing a mesh, according to an embodiment. To facilitate an understanding of the various aspects of the method 100, reference will also made, in turn, to the conceptual depictions of FIGS. 2-6, with continuing reference to FIG. 1.

The method 100 may begin by representing a domain, e.g., a volume or area, in a model, using discrete elements and a mesh, as at 102. In various embodiments, the model may be constructed in modeling applications, computer-aided design (CAD) applications, seismic or geological modeling applications, and the like. It will be appreciated that the method 100 may be tailored for use with any such applications and/or others. Accordingly, the model may be preconstructed, and thus at 102, the method 100 may generally involve receiving the model. In other cases, the method 100 may receive data in a raw format, which may then be modeled as part of the receiving at 102. The domain may be represented in two, three, or more dimensions.

With continuing reference to FIG. 1, FIG. 2 depicts a conceptual, two-dimensional view of a domain 200, which may be discretized into discrete elements 202. The elements 202 may conceptually represent two-dimensional pixels, three-dimensional voxels, or higher-dimensional elements, with it being appreciated that the method 100 may apply in contexts with any number of dimensions. The discrete elements 202 include boundary elements 204, which are shown hatched and may be located at the edges or “boundaries” of an object defined in the domain 200. The empty elements 206 may represent regions of the domain 200 considered to be not a part of the modeled object, or which may be internal to the object, such that they are not on the boundary. A given domain 200 may thus generally include three types of elements 202: boundary elements 204, interior elements (i.e., those elements that are within a defined object, but not on the boundary), and external elements (i.e., those elements that are outside the defined object, or are otherwise undefined). The term “non-boundary elements” refers generically to the latter two types of elements, i.e., interior and external elements.

FIG. 3 illustrates an example of a mesh 300 overlaid on the discrete elements 202, so as to define a surface of the object, according to an embodiment. In particular, the mesh 300 may be associated with each of the boundary elements 204. The mesh 300 may generally be defined by a plurality of surface primitives 302. The primitives 302 may generally be triangular or, as conceptually depicted, squares; however, any other shape for the surface primitives 302 may be employed. Further, the mesh 300 includes a set of vertices 304 (e.g. three for each primitive 302 in a triangular primitive embodiment) and, in some embodiments, a set of normal vectors may be stored for each primitive 302 to distinguish between the two sides (e.g., inward and outward with respect to the object) thereof. The mesh 300 may be regular or irregular, which may determine if the primitives 302 are equally spaced or not. The mesh 300 may be displayed using a “draw style” that may be made up of lines showing connections between vertices 304, or solid, i.e., depicted as a material.

The mesh 300 may be generated in any number of ways. For example, the mesh 300 may be generated using one or more mesh-generation algorithms that work directly on isolated subsets of the discrete elements 202. In particular, the mesh 300 may be generated using the “marching cubes” algorithm, in which a second grid is laid over the grid of discrete elements 202. The second grid is then sampled to determine which of the elements of the second grid define the surface. The elements of the second grid that define the surface are then processed to determine how the primitives 302 (e.g., triangles) are to be drawn. Multiple elements of the second grid may be associated with each of the discrete elements 202, such that each discrete element 202 is partially “wrapped” (i.e., defines a section of) the surface of the object. In other embodiments, the mesh 300 may be generated using algorithms, such as dual contouring, that define the mesh 300 of the entire solid at once; however, in such cases, some embodiments of the method 100 may affect the water-tightness of the mesh 300.

Referring back to FIG. 1, the method 100 may then proceed to constructing a data structure mapping or otherwise associating the discrete elements 202 with the boundary of the object, as at 104. In one embodiment, the data structure may be a quadTree; in another, the data structure may be an octree. In other embodiments, other tree data structures, or other types of data structures, may be provided. For purposes of illustration, however, the data structure will generally be described herein with reference to a tree, with it being appreciated that any other type of data structure may be employed without departing from the scope of the present disclosure.

In the case of an octree, at each node level, the domain 200 may be partitioned into eight octants. This partitioning may continue recursively until the octants represent the smallest discrete volume represented by the model, or, in the case of models with multiple resolution levels, the smallest discrete representation in the region of the model. In either case, this may be the element-level of the data structure. A node and any child nodes and discrete elements 202 falling under that node may be considered a branch of the tree.

Such tree data structures may be employed in organizing voxels, e.g., boundary elements 204. For example, the boundary elements 204 may each be associated with a non-zero value, while other discrete elements (e.g., internal voids or volumes, or representations of space outside of the object) may have a zero or NULL value. If a branch of the data structure is entirely populated with zero-value or NULL (non-boundary) elements, then the branch may terminate before reaching the element level, indicating that no boundary elements 204 are found in that branch. This may facilitate efficient subsequent identification of boundary elements 204.

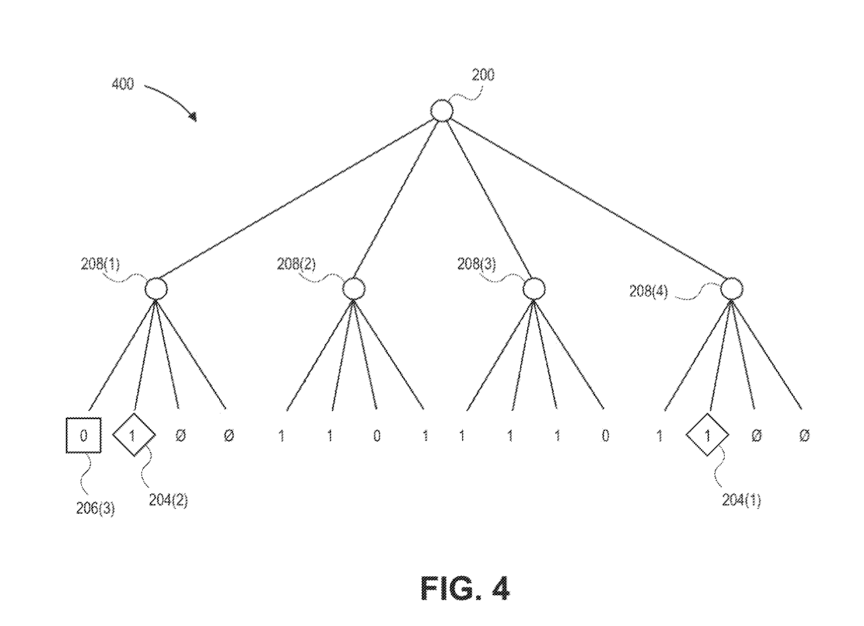

FIG. 4 illustrates an example of a tree data structure (or simply “tree”) 400, according to an embodiment. The tree 400 may include nodes, indicated as circles in FIG. 4. The nodes may include a root node, associated with the entire domain 200, and child nodes, which serve to organize the discrete elements 202 of the domain 200 hierarchically into regions, sub-regions, etc. In the illustrated embodiment, the root node representing the domain 200 is, as indicated in FIGS. 2 and 4, partitioned into the four regions 208(1)-(4). The regions 208(1)-(4) are further partitioned into four discrete elements 202 each.

The tree 400 may include any number of levels, with the illustrated three levels (root, intermediate, and element-level) corresponding to the simplistic example shown in FIGS. 2, 3, 5, and 6. For example, in large volumes with many discrete elements, two or more intermediate levels between the root node and the voxel-level nodes may be included. Moreover, the regions 208(1) and 208(4) may be partially illustrated in FIGS. 2, 3, 5, and 6, or may have fewer discrete elements 202 than the other regions, e.g., because they are on the edge of the domain 200, which may result in the NULL leaves, as shown in FIG. 4, for the non-existent discrete elements.

For purposes of illustration, the identity value of the discrete elements 202 is indicated in the tree 400 by a ‘1’ or a ‘0’ based on whether it is a boundary element 204 or not, respectively, as proceeding in FIG. 2 from left to right, top to bottom for each of the regions 208. If one of the regions 208 were to contain only non-boundary elements 206, then the node representing the region would be NULL, resulting in an early-terminating branch that indicates no further processing of these discrete elements 202 is necessary in boundary determination situations. It will be appreciated that any value or manner of representing the identity of the discrete elements 202 in the tree 400 may be employed. In the illustrated case, however, each of the regions 208 includes at least one boundary element 204, hence none of the regions 208 are null in the tree 400.

Referring again to FIG. 1, the method 100 may then proceed to receiving an instruction to edit a portion of the mesh 300, as at 106. The instruction may be received directly from the user, e.g., via an input peripheral such as a mouse, touchscreen, etc., or according to a predetermined algorithm that may be initiated automatically or by the user. Such algorithms may include at least one of pushing, pulling, smoothing, refining, or decimation, to name just a few among many contemplated. In general, the instruction received at 106 may result in connecting two portions, separating the mesh 300 along a slice line, or more simply expanding or contracting the surface defined by the mesh 300 without slicing or connecting). The process of connecting two portions will be described first, the slicing operation second, and the expanding/contracting third. It will be appreciated that these are merely three examples of operations that may be conducted consistent with the present disclosure.

FIG. 3 illustrates the two portions 308, 310 that are to be connected in this example. In connecting the two portions 308, 310, if the user were permitted to directly edit the mesh 300 to connect the portions 308, 310, or if the mesh 300 were otherwise directly edited, the two portions 308, 310 may be caused to overlap, resulting in a self-intersection of the mesh 300. In the method 100, however, the mesh 300 may not be directly edited according to the method 100, notwithstanding that the mesh 300 may be displayed before, during, and/or after editing, while the discrete elements 202 may be hidden from view. In other cases, the discrete elements 202 may be displayed at any time. In response to receiving the instruction, the method 100 may identify the discrete elements 202 that are to be edited, as at 108, in order to carry out the instruction received at 106.

The identification at 108 of discrete elements 202 to edit may proceed in various ways. For example, the user may select a vertex 304 of the mesh 300 and move it to a new position. As such, the mesh 300 displayed may be a movable visualization, which may be moved by the user to show an enlargement or contraction of the mesh 300. Thus, the method 100 may include displaying a connection developed between portions 308, 310. Identifying at 108 may thus proceed by determining which non-boundary elements 206 are now wrapped by the mesh 300 that were not previously wrapped, with those newly-wrapped voxels being the non-boundary elements 206 to edit.

In another case, determining at 108 may proceed by identifying the boundary elements 204(1) and 204(2) associated with the portions 308, 310 of the mesh 300 being connected. The determining at 108 may then include identifying the non-boundary elements 206 between the identified boundary elements 204(1) and 204(2) that, if changed to boundary elements 204, will bridge the gap between the boundary elements 204(1) and 204(2). This may be employed, for example, in an automated, “hole filling” context. In other cases, various other processes for identifying at 108 may be employed. In the illustrated case, the discrete element 206(3) may be identified as being the voxel to edit.

The method 100 may then proceed to editing, as at 110, the discrete elements (e.g., element 206(3)) identified at 108. Continuing with the present example of connecting the two mesh portions 306, 310, the element 206(3), which was a non-boundary element 206, may be changed to a boundary element 204, as shown in FIG. 5. As such, the boundary elements 204 now define a closed shape for the object. It will be appreciated that a single instruction may result in two or more discrete elements 202 being edited. As such, in at least some cases, the computing associated with the present method 100 may be distributed to several threads or processors, so as to parallelize the operations, e.g., as between different edited elements. It will be appreciated, however, that the method 100 may be otherwise distributed, or may be conducted in a single thread/processor.

The method 100 may then proceed to determining the portion of the mesh 300 to recalculate, based on the discrete elements that are edited, as at 112. Each boundary element 204 may be associated with a particular portion of the mesh 300. Thus, the tree 400 may be queried to assist in establishing whether the edited discrete elements 202 were boundary elements 204 or not, which may establish whether to add or remove a portion of the mesh 300, and where in the mesh 300 this portion is located.

Moreover, in some cases, editing a discrete element 202 from a non-boundary element 206 to a boundary element 204 (and vice versa) may impact the portions of the mesh 300 associated with adjacent (or “neighboring”) boundary elements 204, i.e., those boundary elements 204 that share an edge or a face with the edited element 206(3). For example, if smoothing is applied, and not all corners of the discrete elements 202 are mapped to vertices 304, then editing the discrete elements 202 may result in recalculating the mesh 300 for all the edges in the mesh 300 that are affected, thus potentially impacting the mesh 300 portions associated with adjacent discrete elements 202. In other cases, however, all corners of the discrete elements 202 may be mapped to vertices 304 of the mesh 300, which may obviate a need to recalculate the portion of the mesh 300 associated with the neighboring boundary elements 204.

Considering the former example, where editing the element 206(3) results in a recalculation of the portions of the mesh 300 associated therewith and with the neighboring boundary elements 204, the tree 400 may be again employed to speed the process. Neighboring discrete elements 202, In general, may be rapidly identified in domain 200 space (i.e., the volume or area represented by the discrete elements 202), which may be tied to the relative position of the discrete elements 202. Thus, in at least one context, the neighboring elements may be identified as being plus or minus one in one or more directions. For example, if the edited element 206(3) is stored at the coordinates (i, j, k), then the adjacent elements may be located at (i+a, j+b, k+b), where a, b, and c are all between −1 and 1, inclusive (with the case of a=b=c=0 being ignored). The tree 400 ma then be queried to determine if the discrete elements 202 identified as neighboring are boundary elements 204. Thus, the tree 400 may allow a more rapid determination of the existence of such neighboring boundary elements 204. As shown in the case of FIG. 2, the neighboring boundary elements 204(1), 204(2) (indicated by a diamond in FIG. 4) are identified in the tree 400.

In other cases, the determination at 112 may proceed by identifying one or more specific levels in the tree 400 that include discrete elements 202 associated with the affected portions of the mesh 300. For example, the region-level may be selected, such that regions 208(1) and 208(4), in the example of FIG. 4, are selected by virtue of including the edited element 206(3) and/or one or more neighboring boundary elements 204(1), 204(2). In yet other cases, the determining at 112 may proceed by determining the lowest-level branch of the tree 400 that includes the edited element 206(3) and the neighboring boundary elements 204(1) and 204(2). In the illustrated case, the root node would be the lowest-level, since the boundary elements 204(1) and 204(2) are in different regions 208(1) and 208(4). However, in implementations in which a large number of discrete elements 202 are present, several intermediate-level nodes (i.e., between the root node and the element-level) may be provided, which may reduce the number of elements whose associated mesh portion is identified for recalculation.

The method 100 may then proceed to locally recalculating a portion of the mesh 300, at least in view of the edited element 206(3), as at 114. The recalculating may be considered “local” since, where possible, the mesh 300 may be recalculated for a minimized number of discrete elements 202. For example, as mentioned above, the recalculation of the portion of the mesh 300 associated with the edited element 206(3) may not require the portions of the mesh 300 associated with neighboring boundary elements 204 to be recalculated. As such, the portion of the mesh 300 that is recalculated may be limited to the portion of the mesh 300 associated with the edited element 206(3). Alternatively, the recalculating may be local, since the mesh 300 may be recalculated for the portion thereof associated with the edited element 206(3) and the neighboring boundary elements 204(1) and 204(2), while the remaining portions of the mesh 300 are unaffected. In still other cases, the portion of the mesh 300 associated with a branch of the tree 400 including the edited element 206(3) and any neighboring boundary elements 204 may be recalculated, while the remaining mesh 300 may be unaffected. In the case where a specific level of nodes are chosen, and the nodes within that level being selected based on being associated with the edited element 206(3) and/or the neighboring boundary nodes 204(1), 204(2), the portions of the mesh 300 associated with these nodes (e.g., regions 208(1) and 2080)) may be recalculated, while other portions remain unchanged.

Before, during, or after such mesh recalculation, the method 100 may also include updating the data structure (tree 400), as at 116. Referring again to FIG. 4, the identity value for the identified element 206(3) may change so as to identify the element 206(3) as a boundary element 204. In particular, in this embodiment, it will change from the indicated ‘0’ to ‘1.’ This may conclude at least one portion of the method 100, with the resultant recalculated portion of the mesh 300 being combined with other portions that have been recalculated (e.g., in a parallelized context) and/or otherwise employed in other processes thereafter.

Referring again to receiving the instruction at 106, as mentioned above, the instruction received may be to slice the mesh 300 (i.e., separate part of the mesh into two portions). The slicing process may proceed in a manner similar to the connecting process, except that at least one of the discrete elements 202 is changed from a boundary element 204 to a non-boundary element 206. Accordingly, considering the mesh 300 of FIG. 6, the instruction received at 112 may be to separate the mesh 300 along the line 600. The method 100 may thus identify, as at 108, the one or more discrete elements 202 associated with the portion of the mesh 300 being edited. This may be, for example, the discrete elements 202 that the slice line 600 intersects. Here, again, the identified discrete element 202 is element 206(3) (see FIG. 5). The method 100 may then proceed to editing the element 206(3), as at 110, changing it from a boundary element 204 to a non-boundary element 206.

As with adjoining the portions 308, 310 of the mesh 300, the method 100 may determine the affected portion(s) of the mesh 300, as at 112. For example, determining at 112 may include identifying neighboring boundary elements 204, one or more branches of elements in the tree 400, or simply the portion of the mesh 100 associated with the edited element 206(3). Using that determination, the method 100 may proceed to locally recalculating the mesh 300 portions for the affected elements, as at 114. The method 100 may then include updating the tree 400, as at 116, to account for the changed identity of the edited element 206(3). Moreover, the method 100 may further include displaying the mesh 300 after performing the slicing operation.

Contracting, expanding, or other types of editing that do not include the potential for intersections may also be conducted using embodiments of the method 100. According to an embodiment, the application of the method to carry out such an instruction may be similar to a method previously described in the present disclosure. Briefly, however, the instruction may be to expand or contract the mesh 300, which may be determined to include changing one or more of the discrete elements 202 to/from a boundary element 204 from/to a non-boundary element 206, and then locally recalculating the mesh 300 and updating the data structure accordingly.

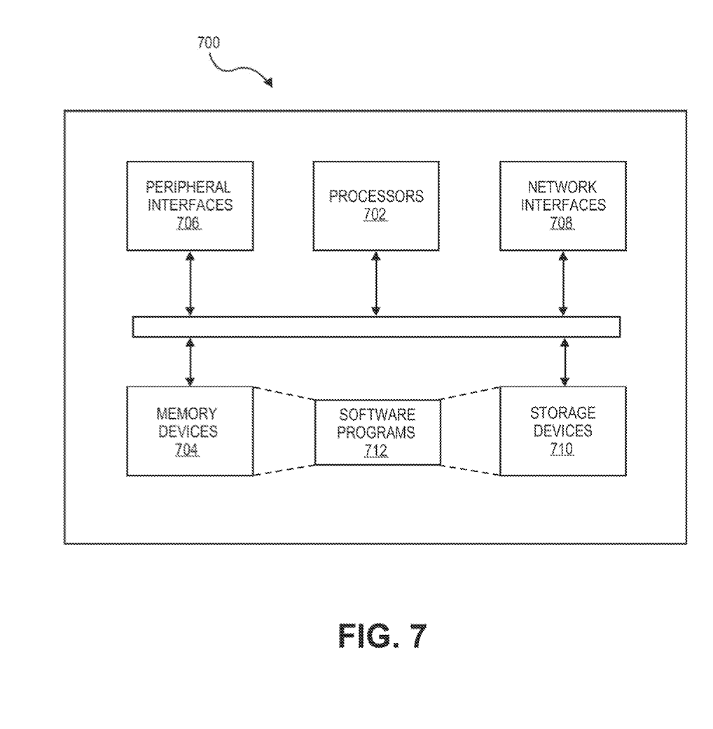

Embodiments of the disclosure may also include one or more systems for implementing one or more embodiments of the method of the present disclosure. FIG. 7 illustrates a schematic view of such a computing or processor system 700, according to an embodiment. The processor system 700 may include one or more processors 702 of varying core (including multiple-core) configurations and clock frequencies. The one or more processors 702 may be operable to execute instructions, apply logic, etc. It will be appreciated that these functions may be provided by multiple processors or multiple cores on a single chip operating in parallel and/or communicably linked together.

The processor system 700 may also include a memory system, which may be or include one or more memory devices and/or computer-readable media 704 of varying physical dimensions, accessibility, storage capacities, etc. such as flash drives, hard drives, disks, random access memory, etc., for storing data, such as images, files, and program instructions for execution by the processor 702. In an embodiment, the computer-readable media 704 may store instructions that, when executed by the processor 702, are configured to cause the processor system 700 to perform operations. For example, execution of such instructions may cause the processor system 700 to implement one or more portions and/or embodiments of the method 100 described above.

The processor system 700 may also include one or more network interfaces 706. The network interfaces 706 may include any hardware, applications, and/or other software. Accordingly, the network interfaces 706 may include Ethernet adapters, wireless transceivers. PCI interfaces, and/or serial network components, for communicating over wired or wireless media using protocols, such as Ethernet, wireless Ethernet, etc.

The processor system 700 may further include one or more peripheral interfaces 708, for communication with a display screen, projector, keyboards, mice, touchpads, sensors, other types of input and/or output peripherals, and/or the like. In some implementations, the components of processor system 700 need not be enclosed within a single enclosure or even located in close proximity to one another, but in other implementations, the components and/or others may be provided in a single enclosure.

The memory device 704 may be physically or logically arranged or configured to store data on one OF more storage devices 710. The storage device 710 may include one or more file systems or databases in any suitable format. The storage device 710 may also include one or more software programs 712, which may contain interpretable or executable instructions for performing one or more of the disclosed processes. When requested by the processor 702, one or more of the software programs 712, or a portion thereof, may be loaded from the storage devices 710 to the memory devices 704 for execution by the processor 702.

Those skilled in the art will appreciate that the above-described componentry is merely one example of a hardware configuration, as the processor system 700 may include any type of hardware components, including any necessary accompanying firmware or software, for performing the disclosed implementations. The processor system 700 may also be implemented in part or in whole by electronic circuit components or processors, such as application-specific integrated circuits (ASICs) or field-programmable gate arrays (FPGAs).

The foregoing description of the present disclosure, along with its associated embodiments and examples, has been presented for purposes of illustration only. It is not exhaustive and does not limit the present disclosure to the precise form disclosed. Those skilled in the art will appreciate from the foregoing description that modifications and variations are possible in light of the above teachings or may be acquired from practicing the disclosed embodiments.

For example, the same techniques described herein with reference to the processor system 700 may be used to execute programs according to instructions received from another program or from another processor system altogether. Similarly, commands may be received, executed, and their output returned entirely within the processing and/or memory of the processor system 700. Accordingly, neither a visual interface command terminal nor any terminal at all is strictly necessary for performing the described embodiments.

Likewise, the steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims in light of their full scope of equivalents. Further, in the above description and in the below claims, unless specified otherwise, the term “execute” and its variants are to be interpreted as pertaining to any operation of program code or instructions on a device, whether compiled, interpreted, or run using other techniques.

What is claimed is:

1. A method for editing a mesh representing a surface, comprising:
receiving a representation of an object, the representation comprising the mesh and a plurality of discrete elements comprising one or more boundary elements, wherein the mesh is associated with the one or more boundary elements;
changing, using a processor, an edited element of the plurality of discrete elements from a boundary element to a non-boundary element or from a non-boundary element to a boundary element; and
locally recalculating, using the processor, a portion of the mesh based on the changing.

2. The method of claim 1, further comprising constructing a data structure associated with the plurality of discrete elements, wherein the data structure stores information related to whether each of the plurality of discrete elements is a boundary element or a non-boundary element.

3. The method of claim 2, the method further comprising updating the data structure to account for changing the edited element.

4. The method of claim 3, wherein updating the data structure comprises changing an identity value of the edited element in the data structure from a value associated with a non-boundary element to a value associated with a boundary element or from a value associated with a boundary element to a value associated with a non-boundary element.

5. The method of claim 2, wherein the data structure comprises an octree.

6. The method of claim 1, wherein the plurality of discrete elements comprises a plurality of three-dimensional voxels.

7. The method of claim 1, wherein the plurality of discrete elements comprises a plurality of two-dimensional pixels.

8. The method of claim 1, further comprising:
determining that a portion of the mesh associated with an affected element of the plurality of discrete elements is affected by changing the edited element, and wherein locally recalculating the portion of the mesh comprises recalculating the portion of the mesh associated with the affected element.

9. The method of claim 1, wherein locally recalculating the portion of the mesh comprises:
identifying neighboring elements of the plurality of discrete elements that are adjacent to the edited element;
determining that at least one of the neighboring elements is a boundary element; and
recalculating a portion of the mesh associated with the at least one of the neighboring elements that is a boundary element.

10. The method of claim 9, further comprising constructing a data structure associated with the plurality of discrete elements, wherein the data structure stores information related to whether each of the plurality of discrete elements is a boundary element or a non-boundary element, wherein determining that the at least one of the neighboring elements is a boundary element comprises querying the data structure.

11. The method of claim 1, further comprising:
receiving an instruction to edit the portion of the mesh;
displaying the mesh before receiving the instruction; and
displaying the mesh after changing the edited element, wherein the plurality of discrete elements are not displayed.

12. The method of claim 11, further comprising:
identifying the edited element after receiving the instruction and before changing the edited element based on a movement of the mesh displayed before the changing.

13. The method of claim 11, wherein receiving the instruction comprises at least one of:
receiving the instruction from a user using an input device; or
conducting a refinement based on a predetermined algorithm, wherein the predetermined algorithm comprises at least one of pushing, pulling, smoothing, refining, or decimation.

14. A computing system, comprising:
one or more processors; and
a memory system comprising one or more non-transitory computer-readable media storing instructions that, when executed by at least one of the one or more processors, cause the computing system to perform operations, the operations comprising:
receiving a representation of an object, the representation comprising the mesh and a plurality of discrete elements comprising one or more boundary elements, wherein the mesh is associated with the one or more boundary elements;
changing an edited element of the plurality of discrete elements from a boundary element to a non-boundary element or from a non-boundary element to a boundary element; and
locally recalculating, using the processor, a portion the mesh based on the changing.

15. The system of claim 14, wherein the operations comprise constructing a data structure associated with the plurality of discrete elements, wherein the data structure stores information related to whether each of the plurality of discrete elements is a boundary element or a non-boundary element.

16. The system of claim 15, wherein the operations further comprise updating the data structure to account for changing the edited element.

17. The system of claim 14, further comprising a display coupled with the one or more processors, wherein the operations further comprise:
receiving an instruction to edit the portion of the mesh;
displaying the mesh using the display before receiving the instruction; and
displaying the mesh using the display after changing the edited element, wherein the plurality of discrete elements are not displayed.

18. A non-transitory computer-readable medium storing instructions that, when executed by a processor of a computing system, cause the computing system to perform operations, the operations comprising:
receiving a representation of an object, the representation comprising the mesh and a plurality of discrete elements comprising one or more boundary elements, wherein the mesh is associated with the one or more boundary elements;
changing an edited element of the plurality of discrete elements from a boundary element to a non-boundary element or from a non-boundary element to a boundary element; and
locally recalculating, using the processor, a portion the mesh based on the changing.

19. The medium of claim 18, wherein the operations further comprise:
constructing a data structure associated with the plurality of discrete elements, wherein the data structure stores information related to whether each of the plurality of discrete elements is a boundary element or a non-boundary element; and
updating the data structure to account for changing the edited element.

20. The medium of claim 18, wherein locally recalculating the portion of the mesh comprises:
identifying neighboring elements of the plurality of discrete elements that are adjacent to the edited element:
determining that at least one of the neighboring elements is a boundary element; and
recalculating a portion of the mesh associated with the at least one of the neighboring elements that is a boundary element.
